(19) United States
(12) Patent Application Publication
(10) Pub. No.: US 2026/0138448 A1
(43) Pub. Date: May 21, 2026

(54) DIALOG DEVICE, DIALOG METHOD, AND STORAGE MEDIUM

(71) Applicant: HONDA MOTOR CO., LTD., Tokyo (JP)

(72) Inventors: Ryo Kimura, Wako-shi (JP); Nobuko Minyu, Wako-shi (JP)

(21) Appl. No.: 19/374,120

(22) Filed: Oct. 30, 2025

(30) Foreign Application Priority Data
Nov. 18, 2024 (JP) 2024-200629

(51) Int. Cl. B60K 35/26; B60K 35/28

(52) U.S. Cl. CPC B60K 35/265; B60K 35/28

(57) ABSTRACT

A dialog device includes an alertness level calculation unit that calculates an alertness level of an occupant of a vehicle based on state information of the occupant, a dialog output unit that, in a case where the calculated alertness level is less than a predetermined value, outputs a dialog to the occupant, an interest degree calculation unit that calculates a degree of interest of the occupant in the dialog based on the state information after the dialog is output, and a dialog generation unit that determines a topic of the dialog based on the calculated degree of interest.

### INCORPORATION BY REFERENCE

The present application claims priority under 35 U.S.C. § 119 to Japanese Patent Application No. 2024-200629 filed on Nov. 18, 2024. The content of the application is incorporated herein by reference in its entirety.

### BACKGROUND OF THE INVENTION

### Field of the Invention

The present invention relates to a dialog device, a dialog method, and a storage medium.

### Description of the Related Art

In recent years, efforts to provide access to a sustainable transportation system while giving consideration to vulnerable people among traffic participants have become active. To implement this, research and development for further improving safety and convenience of traffic through research and development regarding active safety has been focused on.

As related art regarding active safety that further improves safety and convenience of traffic, Japanese Patent Laid-Open No. 2022-024853 discloses a dialog device that acquires an alertness level of an occupant of a vehicle and requests the occupant to speak in a case where the acquired alertness level is less than a threshold. Japanese Patent Laid-Open No. 2019-116216 discloses an excitement allaying device that determines an excitement degree of a driver and performs allaying operation in a case where the excitement degree of the driver exceeds a threshold.

However, the active safety has a problem that in a case where an occupant has little interest in and has little consciousness of a topic of a dialog, an awakening effect may degrade only by the occupant being requested to speak to conduct the dialog.

To solve the problem described above, an object of the present application is to implement a dialog with a high awakening effect for an occupant. Further, eventually, the object of the present application is to contribute to development of a sustainable transportation system.

### SUMMARY OF THE INVENTION

One aspect for achieving the above-described object is a dialog device including an alertness level calculation unit that calculates an alertness level of an occupant of a vehicle based on state information of the occupant, a dialog output unit that, in a case where the calculated alertness level is less than a predetermined value, outputs a dialog to the occupant, an interest degree calculation unit that calculates a degree of interest of the occupant in the dialog based on the state information after the dialog is output, and a dialog generation unit that determines a topic of the dialog based on the calculated degree of interest.

According to the above-described one aspect, it is possible to implement a dialog with a high awakening effect for an occupant.

### BRIEF DESCRIPTION OF THE DRAWINGS

FIG. 1 is a block diagram illustrating a configuration example of a dialog device according to one embodiment;

FIG. 2 is a view illustrating an example of arrangement of a display device, a vehicle interior camera, and a microphone in a vehicle interior of a vehicle on which the dialog device according to the one embodiment is mounted;

FIG. 3 is a flowchart indicating an operation example of the dialog device according to the one embodiment;

FIG. 4 is a flowchart indicating an operation example of the dialog device according to the one embodiment; and

FIG. 5 is a flowchart indicating an operation example of the dialog device according to the one embodiment.

### DETAILED DESCRIPTION OF THE INVENTION

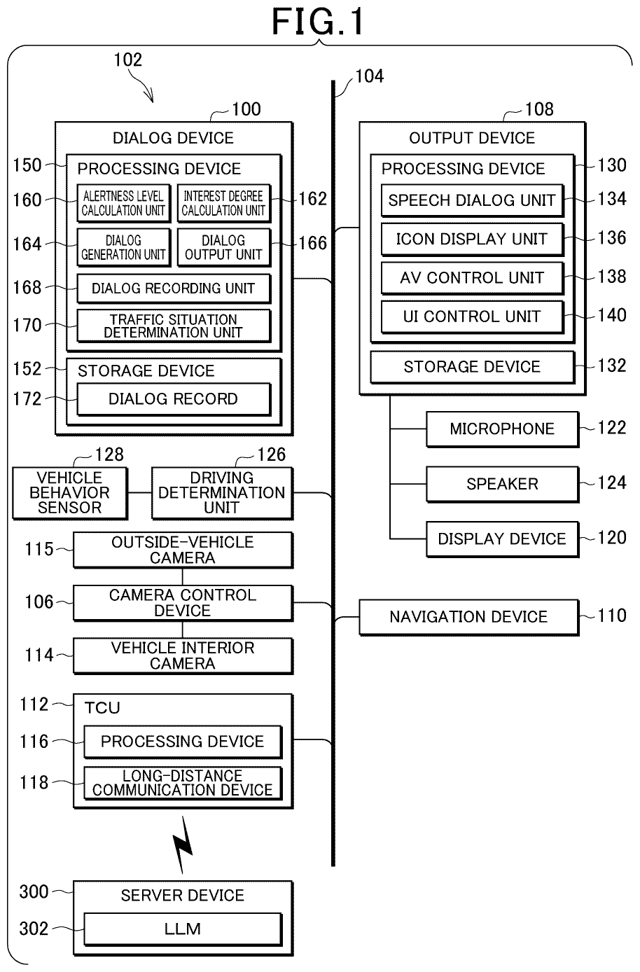

A dialog device according to the present embodiment will be described below with reference to the drawings. FIG. 1 is a block diagram illustrating a configuration example of a dialog device according to one embodiment.

As illustrated in FIG. 1, the dialog device 100 is, for example, mounted on a vehicle 102 that is a moving body. Hereinafter, in the present embodiment, a user is an occupant of the vehicle 102 that is a moving body and includes a driver of the vehicle 102.

The dialog device 100 is communicably connected to, for example, a camera control device 106, an output device 108, a navigation device 110 comprising a computer, a driving determination unit 126 comprising a computer, and a telematics control unit (TCU) 112 via an in-vehicle network bus 104.

The camera control device 106 controls operation of a vehicle interior camera 114 and an outside-vehicle camera 115. Specifically, the camera control device 106 captures a video of at least motion of the user in a vehicle interior of the vehicle 102 with the vehicle interior camera 114 and transmits the captured vehicle interior video to other devices such as the dialog device 100 and the output device 108. Further, the camera control device 106 captures a video of a surrounding situation of the vehicle 102 with the outside-vehicle camera 115 and transmits the captured outside-vehicle video to other devices such as the dialog device 100 and the output device 108. The driving determination unit 126 determines driving operation using data (such as an accelerator, a brake, steering, acceleration/deceleration and yaw) regarding behavior of the vehicle 102 by the driving operation, the data being detected by a vehicle behavior sensor 128. For example, the driving determination unit 126 determines whether or not there is an abnormality in driving operation, such as weaving.

The TCU 112 includes a long-distance communication device 118 including a transmitter and a receiver, and a processing device 116 that controls operation of the long-distance communication device 118. The processing device 116 is, for example, a computer including a processor such as a central processing unit (CPU). The long-distance communication device 118 is, for example, a wireless communication device that communicates with various server devices 300 that provide a dialog service, news and other information via a communication network such as the Internet.

The server device 300 is a server device that provides a dialog service of generating dialog content and replying in response to a prompt including dialog content, and the like, using a large language model (LLM) 302. Here, the prompt is input information including an “instruction”, a “condition”, “reference information”, and the like, to be used by the LLM 302 to generate the dialog content. For example, the “instruction” includes instruction content such as generation of dialog content corresponding to utterance content, a traffic situation, and the like, described in the reference information. The “condition” includes various conditions (such as change/continuation of a topic and notification of a traffic situation) regarding dialog content to be output. The “reference information” includes utterance content, a traffic situation, and the like, that become sources of the dialog content.

The output device 108 is a device that is connected to a display device 120, a microphone 122, and a speaker 124, and outputs sound/video to an occupant (user) of the vehicle 102. For example, the output device 108 outputs a dialog output by the dialog device 100 from the speaker 124 as a speech using a speech synthesis function and collects utterances of the user from the microphone 122. The output device 108 converts the utterances of the user collected from the microphone 122 into text using a speech recognition function and outputs the text to the dialog device 100.

Further, the output device 108 outputs sound by playing music, movies, and the like, by an input instruction from the user via an input device such as a touch panel provided at the display device 120 and/or a spoken instruction in a speech dialog with the user. Further, the output device 108 retrieves and acquires information desired by the user from a server, and the like, on the Internet, for example, via the TCU 112 by an input instruction or a spoken instruction from the user, and outputs the acquired image information and sound information to the display device 120 and the speaker 124. Further, the output device 108 outputs the acquired text information described above to the speaker 124 as a speech using the speech synthesis function.

Specifically, the output device 108 includes a processing device 130 and a storage device 132. The storage device 132 is, for example, constituted with a reading device, and the like, of a detachable storage medium such as a volatile and/or non-volatile semiconductor memory, a hard disk device and/or a compact disc (CD), a digital versatile disc (DVD), and a universal serial bus (USB) memory.

The processing device 130 is a computer including a processor such as a CPU. The processing device 130 includes a speech dialog unit 134, an icon display unit 136, an audio visual (AV) control unit 138, and a user interface (UI) control unit 140 as functional components or functional units to be implemented by programs being executed.

The speech dialog unit 134 outputs a speech of a dialog output by the dialog device 100. Specifically, the speech dialog unit 134 converts dialog content (text) into a speech using the speech synthesis function and outputs the dialog content from the speaker 124. Further, the speech dialog unit 134 converts utterances of the user collected by the microphone 122 into text using the speech recognition function and outputs the text to the dialog device 100.

Further, the speech dialog unit 134 conducts a speech dialog with the user via the UI control unit 140 which will be described later. For example, the speech dialog unit 134 determines whether or not the user utters a specific word (so-called a wake-up word or a trigger word) indicating start of a spoken instruction and if the user utters a wake-up word, recognizes utterances subsequent to the wake-up word as the spoken instruction. Then, the speech dialog unit 134 plays music, movies, and the like, stored in the storage device 132, and the like, reproduces content retrieved from a server, or the like, on the Internet, and/or outputs a speech of text information in accordance with the recognized spoken instruction. Note that start of the dialog in the speech dialog unit 137 is not limited to being triggered by the above-described utterance by the user. For example, the speech dialog unit 137 may start speaking in a push manner from the dialog device 100 side by being triggered by a state of the user, an abnormality in driving operation, or the like, detected based on the video captured by the vehicle interior camera 114 or the outside-vehicle camera 115. For example, in a case where it is determined that the user is tired based on the video of the user by the vehicle interior camera 114, the speech dialog unit 137 speaks such as “You seem to be a little tired, is everything alright?”. Further, in a case where it is determined that the vehicle is weaving based on the video during driving by the outside-vehicle camera 115, the speech dialog unit 137 speaks such as “The vehicle is weaving, is there something disturbing?”. Note that the speech dialog unit 137 may use a determination result of the driving determination unit 126 other than the video by the outside-vehicle camera 115 for an abnormality in the driving operation.

The icon display unit 136 displays a person icon at a portion of a display screen of the display device 120 at least when a speech is output from the speaker 124. Here, as the person icon, an icon simulating a person or an image of a person can be used. Further, the image of the person to be used as the person icon may be an image artificially generated through computer graphics, or the like, in addition to a photograph of the person. Still further, the icon displayed by the icon display unit 136 is not limited to the person icon. For example, the icon display unit 136 may perform display of calling the user's attention by blinking, color, and the like, of light other than the person or may express a presence by changing a shape of the icon.

The AV control unit 138 reproduces AV content such as music, videos and images in accordance with the related art and outputs the AV content to the speaker 124 and/or the display device 120. Such AV content can include, for example, content downloaded by the speech dialog unit 134 from a server, and the like, on the Internet via the TCU 112 by a spoken instruction from the user and stored in the storage device 132 in addition to content stored in a medium such as a DVD to be read by a reading device constituting the storage device 132. Further, the AV control unit 138 outputs sound of a radio program and a TV program received from a receiver (not illustrated) of a broadcast radio wave and a broadcast TV wave to the speaker 124. Still further, the AV control unit 138 outputs a video of a TV program to the display device 120 if appropriate.

The UI control unit 140 controls operation of UI equipment including the display device 120, the microphone 122, and the speaker 124. For example, the UI control unit 140 controls output of sound information via the speaker 124 by an instruction from the dialog device 100. Further, when the UI control unit 140 receives a sound stop instruction from the dialog device 100, the UI control unit 140 stops output of sound information via the speaker 124 and instructs the speech dialog unit 134, the AV control unit 138, and/or the navigation device 110 to stop operation in association with the sound output.

Further, the UI control unit 140 displays an image or a video designated by an instruction at the display device 120 by the instruction from the AV control unit 138, the navigation device 110, and/or the dialog device 100 and transmits an input from the user via a touch panel (not illustrated) equipped on the display device 120 to the AV control unit 138, the navigation device 110, and/or the dialog device 100.

Further, the UI control unit 140 outputs a speech message designated by an instruction to the speaker 124 by the instruction from the AV control unit 138, the navigation device 110, and/or the dialog device 100. Further, the UI control unit 140 acquires utterances such as spoken instructions from the user from the microphone 122 and transmits speech recognition results of the utterances to the AV control unit 138, the navigation device 110, and/or the dialog device 100.

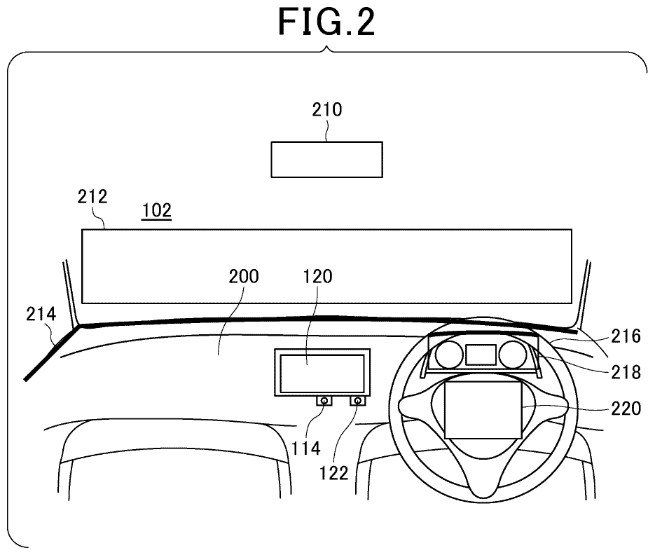

FIG. 2 is a view illustrating an example of arrangement of the display device 120, the vehicle interior camera 114, and the microphone 122 in the vehicle interior of the vehicle 102. As illustrated in FIG. 2, the display device 120 is, for example, arranged at a central portion in a vehicle width direction of an instrument panel 200 of the vehicle 102. The microphone 122 is arranged at a position closer to the driver, below the display device 120. The vehicle interior camera 114 is arranged at a position at which the vehicle interior camera 114 can capture a video of the face of the user (the driver and an occupant in a front passenger's seat). In the example in FIG. 2, the vehicle interior camera 114 is arranged below a central portion of the display device 120. Note that functions and arrangement of the display device 120 are not limited to the above-described example. For example, the display device 120 may perform display at a rearview mirror 210, display at a head-up display to a windshield 212, augmented reality (AR) display, and the like. Further, the display device 120 may perform display at the instrument panel 200, line illumination lighting 214 near the windshield 212, an upper part 216 of the steering wheel, a meter 218, a display 220 inside the steering wheel, and the like. Further, the display device 120 may be a dedicated display unit or a character with a tangible form.

The dialog device 100 includes a processing device 150 and a storage device 152. The storage device 152 is constituted with, for example, a volatile and/or non-volatile semiconductor memory and/or a hard disk device, and the like. The storage device 152 stores a dialog record 172 recording dialog content with the user. The dialog record 172 is information regarding past dialogs with the user recorded by a dialog recording unit 168. For example, the dialog record 172 indicates a state of the user (such as an alertness level and a degree of interest) when the dialog is conducted in association with content of the dialog (such as date and time of the dialog, a dialog sentence, and a topic of the dialog (a category and a keyword)).

The processing device 150 is a computer including a processor such as a CPU. The processing device 150 may have a configuration including a read only memory (ROM) in which programs are written, a random access memory (RAM) for temporarily storing data, and the like. The processing device 150 includes an alertness level calculation unit 160, an interest degree calculation unit 162, a dialog generation unit 164, a dialog output unit 166, the dialog recording unit 168, and a traffic situation determination unit 170 as functional components or functional units to be implemented by programs being executed.

The alertness level calculation unit 160 is a processing unit that calculates an alertness level of the user based on state information of the user such as physiological data of the user, registration information such as an attribute of the user, a video of the user captured by the vehicle interior camera 114, and a speech of the user collected by the microphone 122. For example, the physiological data of the user includes a heart rate, a blood pressure value, a respiration rate, and the like measured by a wearable device, and the like, used by being worn on the user. The registration information of the user includes gender, age, body height, body weight, and the like, of the user. The alertness level calculation unit 160 calculates the alertness level of the user based on the above-described state information of the user using a publicly known alertness level calculation technique. Note that the alertness level calculation unit 160 may calculate the alertness level by utilizing data regarding behavior of the vehicle 102 by driving operation of the user detected by the vehicle behavior sensor 128. Specifically, the alertness level calculation unit 160 calculates the alertness level of the user from steering operation and change of acceleration/deceleration based on data regarding behavior of the vehicle 102 using a publicly known alertness level calculation technique.

For example, the alertness level calculation unit 160 may obtain the alertness level of the user by specifying a state of activity of the user from the physiological data of the user. Further, the alertness level calculation unit 160 may detect an eye opening degree from a shape of the bottom lid and a distance between the top lid and the bottom lid recognized from the video of the user and obtain the alertness level of the user based on the eye opening degree. Still further, the alertness level calculation unit 160 may obtain alertness levels respectively from the physiological data, the registration information, the video of the user and the speech of the user and obtain an average of the alertness levels.

The interest degree calculation unit 162 is a processing unit that calculates a degree of interest of the user in the dialog based on the state information of the user collected after the dialog is output. The state information of the user to be used by the interest degree calculation unit 162 to calculate the degree of interest includes the physiological data of the user, the registration information such as an attribute of the user, the video of the user captured by the vehicle interior camera 114, the speech of the user collected by the microphone 122, and the like, which are similar to the information to be used to calculate the alertness level. Note that information registered in advance before the dialog is used as the registration information such as an attribute of the user, and the like. The interest degree calculation unit 162 calculates the degree of interest of the user based on the state information of the user using a publicly known interest degree calculation technique.

For example, the interest degree calculation unit 162 may obtain a difference in height of a speech (frequency) when the user speaks in response to the dialog from a reference frequency and obtain the degree of interest of the user in the dialog based on the difference in height of the speech. As one example, the interest degree calculation unit 162 calculates a higher degree of interest in a case where the difference in height is equal to or greater than a predetermined value and the speech (frequency) is higher than the reference frequency. Inversely, the interest degree calculation unit 162 calculates a lower degree of interest in a case where the difference in height is within the predetermined value and the speech (frequency) is lower than the reference frequency. Further, the interest degree calculation unit 162 may analyze content uttered by the user with respect to the dialog based on dictionary data and calculate a higher degree of interest in a case where the content includes a predetermined word (such as, for example, exclamatory expression). Further, in a case where the user repeatedly speaks about the same topic, the interest degree calculation unit 162 may calculate a higher degree of interest with respect to the topic. Note that as various kinds of data to be used to calculate the alertness level and the degree of interest, all of those described above may be used or one or a combination of some of them may be used.

The dialog generation unit 164 is a processing unit that generates (determines) dialog content based on an instruction of the dialog output unit 166. Specifically, the dialog generation unit 164 generates a prompt for generating dialog content using the LLM 302 based on the instruction (instruction to generate dialog content) from the dialog output unit 166. The dialog generation unit 164 acquires the dialog content generated using the LLM 302 by transmitting the created prompt to the server device 300 that provides a dialog service using the LLM 302 via the TCU 112. The dialog generation unit 164 outputs the acquired (generated) dialog content to the dialog output unit 166.

The instruction from the dialog output unit 166 includes an instruction to start a dialog, an instruction to pause (restart) the dialog, an instruction to end the dialog, an instruction for making a notification of a traffic situation, and the like. The instruction to start a dialog includes, for example, an instruction to start a dialog by questioning to the user, an instruction to start a dialog by utterance from the user, and the like. The utterance from the user includes data obtained by converting utterance content into text.

In a case where the instruction to start a dialog is received, the dialog generation unit 164 generates a prompt corresponding to start of a dialog (such as, for example, questioning to the user and replying to the utterance from the user) and obtains dialog content upon start of the dialog by transmitting the prompt to the server device 300. Thereafter, the dialog generation unit 164 continuously generates a prompt including in reference information, and the like, data obtained by converting the utterance content of the user acquired by the output device 108 from the microphone 122 into text and generates dialog content that repeats a dialog with the user until other instructions such as an instruction to pause the dialog, an instruction to end the dialog, and an instruction for making a notification of a traffic situation are accepted from the dialog output unit 166.

Here, the dialog generation unit 164 determines a topic of the dialog based on the degree of interest of the user in the dialog, the degree of interest being calculated by the interest degree calculation unit 162. Specifically, the dialog generation unit 164 determines to change the topic to a topic different from a current topic in a case where the degree of interest of the user in the dialog deviates from a predetermined range. In this case, the dialog generation unit 164 generates a prompt that is conditional on change of the topic and transmits the prompt to the server device 300, thereby obtains dialog content that changes the topic.

Concerning a topic to which the current topic is to be changed, the dialog generation unit 164 selects a topic for which the degree of interest of the user falls within the predetermined range. Specifically, the dialog generation unit 164 selects a topic for which the degree of interest of the user falls within the predetermined range based on the degree of the user associated with the topic with reference to the past dialog record 172 with the user.

Further, in a case where an instruction to pause the dialog is accepted, the dialog generation unit 164 generates a prompt for generating dialog content indicating a pause of the dialog and transmits the prompt to the server device 300, thereby obtains dialog content for pausing the dialog. Note that upon restart after the dialog is paused, the dialog generation unit 164 generates a prompt for restarting the dialog and transmits the prompt to the server device 300, thereby obtains dialog content for restarting the dialog.

Further, in a case where an instruction to end the dialog is accepted, the dialog generation unit 164 generates a prompt for generating dialog content indicating end of the dialog and transmits the prompt to the server device 300, thereby obtains dialog content for ending the dialog.

Further, in a case where an instruction for making a notification of a traffic situation is accepted, the dialog generation unit 164 generates a prompt for making a notification of a traffic situation and transmits the prompt to the server device 300, thereby obtains dialog content that makes a notification of the traffic situation.

The dialog output unit 166 is a processing unit that instructs the dialog generation unit 164 to generate dialog content and outputs the dialog content generated by the dialog generation unit 164 to the output device 108. Specifically, the dialog output unit 166 instructs the dialog generation unit 164 to generate dialog content by being triggered by a predetermined condition. The dialog output unit 166 outputs the dialog content generated by the dialog generation unit 164 in response to this instruction to the output device 108. By this means, the output device 108 outputs the dialog content to the user using a speech via the speaker 124.

The predetermined condition to be used by the dialog output unit 166 to give an instruction to generate dialog content includes an utterance of the user collected by the output device 108 via the microphone 122, the state of the alertness level of the user calculated by the alertness level calculation unit 160, the traffic situation around the vehicle 102 determined by the traffic situation determination unit 170, and the like.

For example, in a case of start of a dialog by utterance of the user, the dialog output unit 166 notifies the dialog generation unit 164 of an instruction to start a dialog including data obtained by converting the utterance of the user into text. Note that in a case of end of the dialog by utterance of the user, the dialog output unit 166 notifies the dialog generation unit 164 of an instruction to end the dialog including data obtained by converting the utterance of the user into text.

Further, in a case where the alertness level of the user is less than a predetermined threshold, the dialog output unit 166 notifies the dialog generation unit 164 of an instruction to start a dialog by questioning to the user. By this means, the dialog device 100 can start a dialog with the user so as to awaken the user in a case where the alertness level of the user is low (in a case where the alertness level of the user is less than the predetermined threshold).

Further, in a case where the traffic situation around the vehicle 102 is a predetermined traffic situation in which the user had better pay attention (such as, for example, a road with lane closure, a road under construction, and a high-accident location), the dialog output unit 166 notifies the dialog generation unit 164 of an instruction to pause the dialogue so that the dialog with the user does not inhibit driving.

Further, in a case where the traffic situation around the vehicle 102 is a predetermined traffic situation in which it is better to encourage the user to recognize the situation (such as, for example, a road with lane closure/speed limit and a road under construction), the dialog output unit 166 notifies the dialog generation unit 164 of an instruction for making a notification of the traffic situation. Specifically, the dialog output unit 166 notifies the dialog generation unit 164 of an instruction including data obtained by converting the traffic situation into text to notify the user of the traffic situation determined by the traffic situation determination unit 170.

Note that while the traffic situation in which the user had better pay attention and the traffic situation in which it is better to encourage the user to recognize the situation may partially overlap with each other, they are respectively separately set in advance.

The dialog recording unit 168 is a processing unit that records dialog content with the user as the dialog record 172. Specifically, the dialog recording unit 168 records the dialog record 172 in which a state of the user upon the dialog (such as the alertness level and the degree of interest) is associated with content of the dialog (such as date and time of the dialog, a dialog sentence and the topic of the dialog (a category and a keyword)). Here, the dialog recording unit 168 acquires the topic of the dialog (the category and the keyword) using a publicly known document analysis technique with respect to the dialog sentence.

The traffic situation determination unit 170 is a processing unit that determines the traffic situation around the vehicle 102. Specifically, the traffic situation determination unit 170 acquires road traffic information (such as a traffic congestion, speed limit/lane closure, a road under construction, and a high-accident location) around the vehicle 102 via the TCU 112 by a server device (not illustrated) that provides the road traffic information. The traffic situation determination unit 170 determines the traffic situation around the vehicle 102 based on this road traffic information. Further, the traffic situation determination unit 170 may determine the traffic situation around the vehicle 102 based on the video around the vehicle 102 captured by the outside-vehicle camera 115 by using a publicly known image recognition technique.

For example, the traffic situation determination unit 170 determines whether or not the traffic situation is a predetermined traffic situation in which the user needs to pay attention. Note that examples of the predetermined traffic situation in which the user needs to pay attention can include a situation in which the vehicle 102 is located near an intersection, a lane of the road is closed, the vehicle 102 is located at a high-accident location, a traffic light is yellow (will turn red immediately), a pedestrian, a bike, or a bicycle is passing by the vehicle 102, and the like.

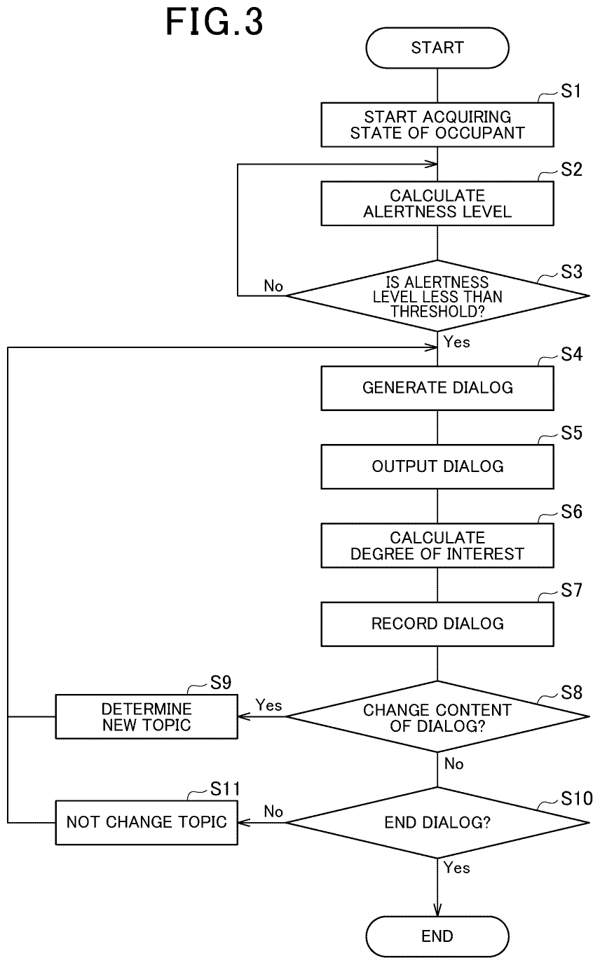

Operation of the dialog device 100 will be described next with reference to FIGS. 3 to 5. FIGS. 3 to 5 are flowcharts indicating operation examples of the dialog device 100 according to one embodiment.

As indicated in FIG. 3, if the processing is started, the dialog device 100 starts acquiring the state of the user (occupant) by the vehicle interior camera 114, the microphone 122, and the like (S1).

Then, the alertness level calculation unit 160 calculates the alertness level of the user based on the state information of the user (S2). Then, the dialog output unit 166 determines whether or not the calculated alertness level of the user is less than a predetermined threshold (S3). In a case where the alertness level of the user is not less than the predetermined threshold (S3: No), the processing of the dialog output unit 166 returns to S2.

In a case where the alertness level of the user is less than the predetermined threshold (S3: Yes), the dialog output unit 166 notifies the dialog generation unit 164 of an instruction to start a dialog. The dialog generation unit 164 that receives the instruction to start a dialog generates dialog content and outputs the dialog content to the dialog output unit 166 (S4). The dialog output unit 166 outputs the dialog content generated by the dialog generation unit 164 to the user via the output device 108 (S5).

Then, the interest degree calculation unit 162 calculates the degree of interest of the user in the dialog based on the state information of the user collected after the dialog is output (S6). The dialog recording unit 168 records the dialog record 172 in which the state of the user (such as the alertness level and the degree of interest) upon this dialog is associated with content of the dialog (S7).

Then, the dialog generation unit 164 determines whether or not to change the content (topic) of the dialog based on the degree of interest of the user in the dialog calculated by the interest degree calculation unit 162 (S8). Specifically, in a case where the degree of interest of the user in the dialog deviates from a predetermined range, the dialog generation unit 164 determines to change the topic.

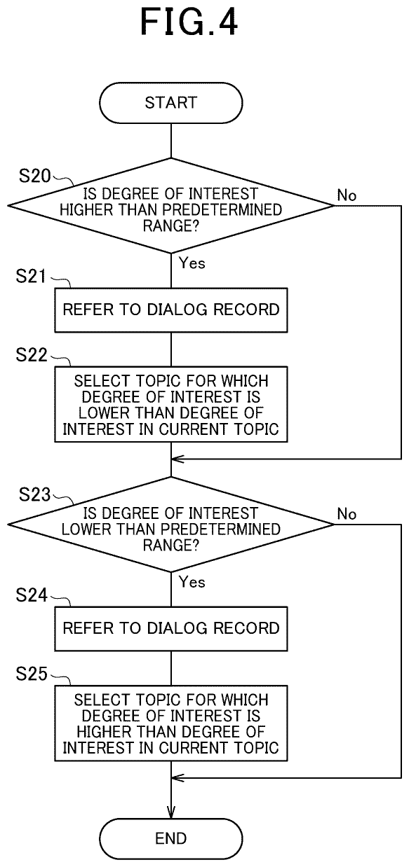

In a case where it is determined to change the topic (S8: Yes), the dialog generation unit 164 determines a new topic different from the current topic (S9), and the processing returns to S4. Here, determination of the new topic will be described with reference to FIG. 4.

As illustrated in FIG. 4, first, the dialog generation unit 164 determines whether or not the degree of interest of the user in the dialog is higher than the predetermined range (S20). In a case where the degree of interest of the user in the dialog is not higher than the predetermined range (S20: No), the processing of S21 and S22 is skipped, and the processing of the dialog generation unit 164 proceeds to S23.

In a case where the degree of interest of the user in the dialog is higher than the predetermined range (S20: Yes), the dialog generation unit 164 refers to the traffic situation determination unit 170 (S21) to select a topic with a degree of interest lower than the degree of interest of the user calculated for the current topic, from past topics recorded in the traffic situation determination unit 170 (S22). More specifically, the dialog generation unit 164 selects a topic with a degree of interest lower than the calculated degree of interest of the user from the past topics for which degrees of interest fall within the predetermined range. Note that in a case where a plurality of corresponding topics exists, the dialog generation unit 164 selects a topic with a lower degree of interest among them. Note that the dialog generation unit 164 may randomly select a topic in a case where accuracy of calculation of the degree of interest is low, and the degree of interest in each topic is not sufficiently specified. Here, the case where the accuracy of calculation of the degree of interest is low includes a case where the number of cases (the number of samples) to be used for calculating the degree of interest is not equal to or larger than a certain number. Further, in a case where the degree of interest is calculated using a machine learning model, there is a case where learning of the machine learning model has not sufficiently proceeded, and accuracy of the machine learning model is low. In this manner, in a case where the degree of interest in each topic is not sufficiently specified, the dialog generation unit 164 may randomly select a topic until the degree of interest can be specified with high accuracy.

Then, the dialog generation unit 164 determines whether or not the degree of interest of the user in the dialog is lower than the predetermined range (S23). In a case where the degree of interest of the user in the dialog is not lower than the predetermined range (S23: No), the processing of S24 and S25 is skipped, and the dialog generation unit 164 ends the processing from S23.

In a case where the degree of interest of the user in the dialog is lower than the predetermined range (S23: Yes), the dialog generation unit 164 refers to the traffic situation determination unit 170 (S24) to select a topic with a degree of interest higher than the degree of interest of the user calculated for the current topic from the past topics recorded in the traffic situation determination unit 170 (S25). More specifically, the dialog generation unit 164 selects a topic with a degree of interest higher than the calculated degree of interest of the user from the past topics for which the degrees of interest fall within the predetermined range. Note that in a case where a plurality of corresponding topics exists, the dialog generation unit 164 selects a topic with a higher degree of interest among them.

Returning to FIG. 3, in a case where it is determined not to change the topic (S8: No), the dialog output unit 166 determines whether or not to end the dialog (S10). For example, in a case where there is no instruction to end the dialog by utterance of the user, the dialog output unit 166 continues (does not end) the dialog.

In a case where it is determined to continue the dialog (S10: No), the dialog generation unit 164 continuously generates a prompt regarding the dialog without changing the topic and generates dialog content that repeats the dialog with the user. The dialog output unit 166 outputs the dialog content generated by the dialog generation unit 164 to the user by the output device 108 and continues the dialog without changing the topic (S11).

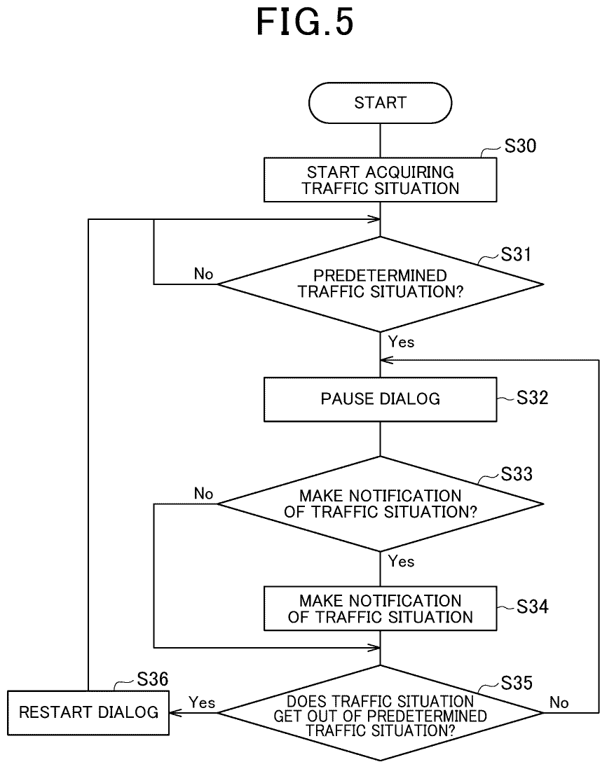

Then, the dialog in accordance with the traffic situation around the vehicle 102 will be described with reference to FIG. 5. As illustrated in FIG. 5, if the processing is started, the traffic situation determination unit 170 starts acquiring the traffic situation (S30).

Then, the traffic situation determination unit 170 determines whether or not the traffic situation is a predetermined traffic situation in which the user needs to pay attention (such as, for example, a road with lane closure, a road under construction, and a high-accident location) (S31). In a case where the traffic situation is not the predetermined traffic situation (S31: No), the traffic situation determination unit 170 stands by for the processing.

In a case where the traffic situation is the predetermined traffic situation (S31: Yes), the dialog output unit 166 notifies the dialog generation unit 164 of an instruction to pause the dialog and pauses the dialog with the user (S32).

Then, the traffic situation determination unit 170 determines whether the traffic situation is a predetermined traffic situation in which it is better to encourage the user to recognize the situation (such as, for example, a road with lane closure/speed limit and a road under construction) and determines whether or not to make a notification of the traffic situation (encourage the user to recognize the situation) (S33). In a case where it is determined not to make a notification of the traffic situation (S33: No), the processing of S34 is skipped, and the processing of the traffic situation determination unit 170 proceeds to S35.

In a case where it is determined to make a notification of the traffic situation (S33: Yes), the dialog output unit 166 notifies the dialog generation unit 164 of an instruction to make a notification of the traffic situation and notifies the user of the traffic situation (S34).

Then, the traffic situation determination unit 170 determines whether or not the traffic situation around the vehicle 102 gets out of the predetermined traffic situation in which the user needs to pay attention (S35). In a case where the traffic situation does not get out of the predetermined traffic situation (S35: No), the processing of the traffic situation determination unit 170 returns to S32. Thus, in a case where the traffic situation does not get out of the predetermined traffic situation, the pause of the dialog is continued.

In a case where the traffic situation gets out of the predetermined traffic situation (S35: Yes), the dialog output unit 166 notifies the dialog generation unit 164 of an instruction to restart the dialog and restarts the dialog (S36), and the processing returns to S31.

As described above, the dialog device 100 includes the alertness level calculation unit 160, the dialog output unit 166, the interest degree calculation unit 162, and the dialog generation unit 164. The alertness level calculation unit 160 calculates the alertness level of the user based on the state information of the user (occupant) of the vehicle 102. The dialog output unit 166 outputs the dialog to the user in a case where the calculated alertness level is less than a predetermined value. The interest degree calculation unit 162 calculates the degree of interest of the user in the dialog based on the state information of the user after the dialog is output. The dialog generation unit 164 determines a topic of the dialog based on the calculated degree of interest.

Thus, in the dialog device 100, the topic of the dialog is determined based on the degree of interest of the user in the dialog, so that it is possible to avoid a dialog that degrades an awakening effect as a result of the user having low interest in the dialog and consciousness being fading. Thus, the dialog device 100 can maintain conversation with a high awakening effect for the user.

Further, the dialog generation unit 164 determines a topic of the dialog for which the degree of interest of the user falls within the predetermined range.

Thus, the dialog device 100 can avoid a dialog that degrades an awakening effect as a result of the degree of interest of the user becoming low and inversely can avoid a situation in which the user pays too much attention to the dialog as a result of the degree of interest of the user becoming high.

Further, the dialog device 100 includes the dialog recording unit 168 that records the degree of interest calculated for the dialog and the topic of the dialog in the dialog record 172 in association with each other. The dialog generation unit 164 determines the topic of the dialog associated with the predetermined degree of interest recorded in the traffic situation determination unit 170.

Thus, the dialog device 100 can determine an appropriate topic of a dialog for which the degree of interest of the user falls within the predetermined range by utilizing a correspondence relationship between the topic of the dialog and the degree of interest of the user recorded in the dialog record 172.

Further, in a case where the calculated degree of interest is lower than the predetermined range, the dialog generation unit 164 selects a topic of a dialog corresponding to a degree of interest higher than the calculated degree of interest from the topics of the dialogs recorded in the dialog record 172.

Thus, in a case where the degree of interest of the user is low, the dialog device 100 can change the topic of the dialog so as to awaken more interest and can lead the topic so that the degree of interest of the user falls within the predetermined range.

Further, in a case where the calculated degree of interest is higher than the predetermined range, the dialog generation unit 164 selects a topic of a dialog corresponding to a degree of interest lower than the calculated degree of interest from the topics of the dialogs recorded in the dialog record 172.

Thus, in a case where the degree of interest of the user is high, the dialog device 100 can change the topic of the dialog to the topic that does not awaken much interest to avoid the user from becoming caught up in the dialog and can lead the topic so that the degree of interest of the user falls within the predetermined range.

Further, the dialog device 100 includes the traffic situation determination unit 170 that determines the traffic situation around the vehicle 102. The dialog output unit 166 pauses output of the dialog in a case where the traffic situation determined by the traffic situation determination unit 170 is a predetermined traffic situation.

Thus, the dialog device 100 can assist the user in driving so that the user can concentratedly cope with the traffic situation by pausing the dialog in a case where the traffic situation is the predetermined traffic situation.

Further, in a case where the traffic situation determined by the traffic situation determination unit 170 is the predetermined traffic situation, the dialog output unit 166 outputs a notification corresponding to the traffic situation. Note that the dialog output unit 166 may make a speech (voice quality) in a case of outputting the notification corresponding to the traffic situation, different from other speeches. For example, the dialog output unit 166 outputs the notification with high-pitched voice quality and with a sense of tension because the notification is the notification of the traffic situation directly related to driving unlike with conversation (dialog) to the user by the dialog device 100. In this manner, the dialog output unit 166 may perform output so as to differentiate the connection between the voice quality and the event (traffic situation) from other connections by making a notification of the traffic situation with the voice quality different from voice quality of the conversation (dialog) to the user.

Thus, the dialog device 100 can assist the user in driving so that the user can easily recognize that the traffic situation is the predetermined situation and concentratedly cope with the traffic situation.

Note that the above-described embodiment exemplifies the technique in the present disclosure, and thus, various changes, replacements, additions, omissions, and the like, can be made within the scope of the claims and its equivalent scope.

For example, while a configuration using a dialog service by the LLM 302 of the server device 300 has been exemplified regarding creation of the dialog content in the dialog generation unit 164 of the dialog device 100 described above, the dialog generation unit 164 may create the dialog content alone. In other words, the dialog device 100 described above may provide the dialog service by the LLM. Specifically, the storage device 152 stores learning model information of a model that is machine-learned to output conversation content (dialog) to the user in response to an input of utterance content from the user and a condition of the dialog such as a topic. The dialog generation unit 164 inputs the utterance content from the user and the condition of the dialog such as a topic to the model constructed based on this learning model information. By this means, the dialog generation unit 164 obtains an output of the model, that is, dialog content.

Further, a configuration of each unit of the dialog device 100 illustrated in FIG. 1 is an example, and a specific implementation form is not particularly limited. In other words, it is not always necessary to implement hardware individually corresponding to each unit, and it is, of course, possible to employ a configuration in which functions of each unit are implemented by one processor executing programs. Further, some of the functions to be implemented by software in the above-described embodiment may be implemented by hardware or some of the functions to be implemented by hardware may be implemented by software.

Further, a unit of step of operation in the processing device 150 in FIG. 1 is obtained by dividing the processing in accordance with main processing content, and the present disclosure is not limited by a way of dividing the processing into units of processing and name. The processing may be divided into more units of step in accordance with processing content. Further, the processing may be divided so that one unit of step includes more kinds of processing. Further, order of the steps may be replaced as appropriate within a range not affecting the spirit of the present disclosure.

Further, in a case where a dialog method by a computer such as the processing device 150 of the dialog device 100 described above is implemented using a processor, a dialog program to be executed by the processor can be constituted in an aspect of a recording medium or a transmission medium that transmits the dialog program. In other words, the above-described dialog program can be implemented in a state where the dialog program is recorded in a portable information recording medium. While examples of the information recording medium can include a magnetic recording medium such as a hard disk, an optical recording medium such as a CD, and a semiconductor storage device such as a universal serial bus (USB) memory and a solid state drive (SSD), other recording media can be used.

### [Configurations Supported By The Above-Described Embodiment]

The above-described embodiment supports the following configurations.
(Configuration 1) A dialog device including an alertness level calculation unit that calculates an alertness level of an occupant of a vehicle based on state information of the occupant, a dialog output unit that, in a case where the calculated alertness level is less than a predetermined value, outputs a dialog to the occupant, an interest degree calculation unit that calculates a degree of interest of the occupant in the dialog based on the state information after the dialog is output, and a dialog generation unit that determines a topic of the dialog based on the calculated degree of interest.

According to the dialog device of configuration 1, it is possible to determine the topic of the dialog based on the degree of interest of the occupant in the dialog and implement a dialog with a high awakening effect for the occupant.
(Configuration 2) The dialog device according to configuration 1, in which the dialog generation unit determines the topic of the dialog for which the degree of interest of the occupant falls within a predetermined range.

According to the dialog device of configuration 2, it is possible to maintain a dialog for which the degree of interest of the occupant does not become too high and does not become too low.
(Configuration 3) The dialog device according to configuration 2, further including a dialog recording unit that records the degree of interest calculated for the dialog and the topic of the dialog in association with each other, in which the dialog generation unit determines a topic of a dialog associated with a predetermined degree of interest recorded in the dialog recording unit.

According to the dialog device of configuration 2, it is possible to determine the topic of the dialog with the occupant from past results recorded in the dialog recording unit.
(Configuration 4) The dialog device according to configuration 3, in which in a case where the calculated degree of interest is lower than the predetermined range, the dialog generation unit selects a topic of a dialog corresponding to the degree of interest higher than the calculated degree of interest from topics of dialogs recorded in the dialog recording unit.

According to the dialog device of configuration 4, it is possible to change the topic to a topic of a dialog that awakens more interest in a case where the degree of interest of the occupant is low.
(Configuration 5) The dialog device according to configuration 3, in which in a case where the calculated degree of interest is higher than the predetermined range, the dialog generation unit selects a topic of a dialog corresponding to the degree of interest lower than the calculated degree of interest from topics of dialogs recorded in the dialog recording unit.

According to the dialog device of configuration 5, it is possible to change the topic to a topic of a dialog that does not awaken much interest in a case where the degree of interest of the occupant is high.
(Configuration 6) The dialog device according to configuration 1, further including a traffic situation determination unit that determines a traffic situation around the vehicle, in which in a case where the determined traffic situation is a predetermined traffic situation, the dialog output unit pauses output of the dialog.

According to the dialog device of configuration 6, it is possible to assist the occupant in driving so that the occupant can concentratedly cope with the traffic situation instead of the dialog.
(Configuration 7) The dialog device according to configuration 1, further including a traffic situation determination unit that determines a traffic situation around the vehicle, in which in a case where the determined traffic situation is a predetermined traffic situation, the dialog output unit outputs a notification corresponding to the traffic situation.

According to the dialog device of configuration 7, it is possible to allow the occupant to easily recognize the predetermined traffic situation and assist the occupant in driving.
(Configuration 8) A dialog method in which a computer executes processing of calculating an alertness level of an occupant based on state information of the occupant, in a case where the calculated alertness level is less than a predetermined value, outputting a dialog to the occupant, calculating a degree of interest of the occupant in the dialog based on the state information after the dialog is output, and determining a topic of the dialog based on the calculated degree of interest.

According to the dialog method of configuration 8, effects equivalent to those of the above-described configuration 1 are provided.
(Configuration 9) A non-transitory computer-readable storage medium storing a dialog program causing a computer to execute processing of calculating an alertness level of an occupant based on state information of the occupant, in a case where the calculated alertness level is less than a predetermined value, outputting a dialog to the occupant, calculating a degree of interest of the occupant in the dialog based on the state information after the dialog is output, and determining a topic of the dialog based on the calculated degree of interest.

According to the dialog program of configuration 9, effects equivalent to those of the above-described configuration 1 are provided.

### REFERENCE SIGNS LIST

100 Dialog device
102 Vehicle
104 In-vehicle network bus
106 Camera control device
108 Output device
110 Navigation device
112 TCU
114 Vehicle interior camera
115 Outside-vehicle camera
116 Processing device
118 Long-distance communication device
120 Display device
122 Microphone
124 Speaker
126 Driving determination unit
128 Vehicle behavior sensor
130 Processing device
132 Storage device
134 Speech dialog unit
136 Icon display unit
138 AV control unit
140 UI control unit
150 Processing device
152 Storage device
160 Alertness level calculation unit
162 Interest degree calculation unit
164 Dialog generation unit
166 Dialog output unit
168 Dialog recording unit
170 Traffic situation determination unit
172 Dialog record
200 Instrument panel
210 Rearview mirror
212 Windshield
214 Line illumination lighting
216 Upper part of steering wheel
218 Meter
220 Display inside steering wheel
300 Server device
302 LLM

1. A dialog device comprising:
an alertness level calculation unit that calculates an alertness level of an occupant of a vehicle based on state information of the occupant;
a dialog output unit that, in a case where the calculated alertness level is less than a predetermined value, outputs a dialog to the occupant;
an interest degree calculation unit that calculates a degree of interest of the occupant in the dialog based on the state information after the dialog is output; and
a dialog generation unit that determines a topic of the dialog based on the calculated degree of interest.

2. The dialog device according to claim 1, wherein the dialog generation unit determines the topic of the dialog for which the degree of interest of the occupant falls within a predetermined range.

3. The dialog device according to claim 2, further comprising:
a dialog recording unit that records the degree of interest calculated for the dialog and the topic of the dialog in association with each other,
wherein the dialog generation unit determines a topic of a dialog associated with a predetermined degree of interest recorded in the dialog recording unit.

4. The dialog device according to claim 3, wherein in a case where the calculated degree of interest is lower than the predetermined range, the dialog generation unit selects a topic of a dialog corresponding to the degree of interest higher than the calculated degree of interest from topics of dialogs recorded in the dialog recording unit.

5. The dialog device according to claim 3, wherein in a case where the calculated degree of interest is higher than the predetermined range, the dialog generation unit selects a topic of a dialog corresponding to the degree of interest lower than the calculated degree of interest from topics of dialogs recorded in the dialog recording unit.

6. The dialog device according to claim 1, further comprising:
a traffic situation determination unit that determines a traffic situation around the vehicle,
wherein in a case where the determined traffic situation is a predetermined traffic situation, the dialog output unit pauses output of the dialog.

7. The dialog device according to claim 1, further comprising:
a traffic situation determination unit that determines a traffic situation around the vehicle,
wherein in a case where the determined traffic situation is a predetermined traffic situation, the dialog output unit outputs a notification corresponding to the traffic situation.

8. A dialog method in which a computer executes processing of:
calculating an alertness level of an occupant based on state information of the occupant;
in a case where the calculated alertness level is less than a predetermined value, outputting a dialog to the occupant;
calculating a degree of interest of the occupant in the dialog based on the state information after the dialog is output; and
determining a topic of the dialog based on the calculated degree of interest.

9. A non-transitory computer-readable storage medium storing a dialog program causing a computer to execute processing of:
calculating an alertness level of an occupant based on state information of the occupant;
in a case where the calculated alertness level is less than a predetermined value, outputting a dialog to the occupant;
calculating a degree of interest of the occupant in the dialog based on the state information after the dialog is output; and
determining a topic of the dialog based on the calculated degree of interest.
